(19) United States
(12) Patent Application Publication
(10) Pub. No.: US 2026/0036178 A1
(43) Pub. Date: Feb. 5, 2026

(54) OSCILLATING INERTIAL LATCH

(71) Applicant: Tesla, Inc., Austin, TX (US)

(72) Inventor: Joshi Shreyash, San Jose, CA (US)

(21) Appl. No.: 18/996,482

(22) PCT Filed: Jun. 15, 2023
(86) PCT No.: PCT/US2023/025404

§ 371 Date: Jan. 17, 2025

Related U.S. Application Data
(60) Provisional application No. 63/368,865, filed on Jul. 19, 2022.

(51) Int. Cl. F16D 59/00; B60N 2/42; F16D 63/00; F16D 121/14; F16D 127/00

(52) U.S. Cl. CPC F16D 59/00; F16D 63/006; B60N 2/43; F16D 2121/14; F16D 2127/002

(57) ABSTRACT

An inertial latch includes a swash plate, a swing arm. The swing arm can have a first end and a second end, the first end being configured to pivot on the swash plate so that the swing arm moves between a first position and a second position, and the second end comprising a plurality of teeth. The inertial latch can further include a spring that can connect the swash plate and the swing arm. The spring is configured to apply a force on the swing arm to bias the swing arm in a direction towards the first position. The inertial latch can also include a ratchet ring comprising a plurality of teeth configured to be engaged by the plurality of teeth of the swing arm when the swing arm pivots to the second position due to a high acceleration event.

### CROSS-REFERENCE TO RELATED APPLICATIONS

This application claims the benefit of U.S. provisional application No. 63/368,865, filed Jul. 19, 2022, the entire disclosure of which is hereby incorporated by reference in its entirety.

### TECHNICAL FIELD

The present application relates to an inertial latch. More particularly, the inertial latch can lock two relatively rotatable bodies in response to a force.

### BACKGROUND

A vehicle can have many rotatable parts, such as, armrests, seat backs, center consoles, etc. During high acceleration events, these rotatable parts can move unexpectedly because of inertia. For example, a raised armrest in a vertical position can abruptly swivel down during a crash. Such high acceleration events can include rapid speeding or braking that can have an acceleration or deceleration exceeding 1 g, or a crash event that is usually associated with a deceleration exceeding 3 g. An inertial latch can utilize inertia and lock two relatively rotating bodies when a high acceleration event occurs.

### SUMMARY

The disclosure relates generally to an inertial latch. More specifically, various embodiments of this disclosure relate to an inertial latch that can be used on a vehicle to lock rotatable parts under heavy braking or forward collision.

An aspect is directed to an inertial latch comprising a swash plate, a swing arm, a spring, and a ratchet ring. The swing arm can include a first end and a second end, the first end being configured to pivot on the swash plate so that the swing arm moves between a first position and a second position, the second end comprising a plurality of teeth. The spring can connect the swash plate and the swing arm, the spring being configured to apply a force on the swing arm to bias the swing arm in a direction towards the first position. The ratchet ring can have a plurality of teeth configured to be engaged by the plurality of teeth of the swing arm when the swing arm pivots to the second position due to a high acceleration event.

A variation of the aspect is, wherein the first end of the swing arm is pivot at a point proximate an edge of the swash plate.

A variation of the aspect is, wherein the second end of the swing arm is proximate an edge of the swash plate in the first position.

A variation of the aspect is, wherein the spring connects to the swash plate proximate an edge of the swash plate.

A variation of the aspect is, wherein the high acceleration event is when the inertial latch is under an acceleration or deceleration at or exceeding 1 g.

A variation of the aspect is, wherein the high acceleration event is when the inertial latch is under an acceleration or deceleration at or exceeding 3 g.

A variation of the aspect is, wherein, in the first position, the swing arm is substantially secured by and between the spring arm and a swing arm stopper.

A variation of the aspect is, wherein the swing arm stopper is positioned on the swash plate.

A variation of the aspect is, wherein, in the second position, the plurality of teeth on the second end of the swing arm locks into the plurality of teeth on the ratchet ring.

A variation of the aspect is, wherein the swash plate is connected to a pivoted part.

A variation of the aspect is, wherein the pivoted part can rotate with the swash plate when the swing arm is in the first position.

A variation of the aspect is, wherein the pivoted part is locked in place when then swing arm is in the second position.

A variation of the aspect is, wherein the swash plate comprises an anti-rotation hole.

A variation of the aspect is, wherein the anti-rotation hole extends from a center of the swash plate towards a periphery of the swash plate.

A variation of the aspect is, wherein the anti-rotation hole is sized and shaped to receive an interlocking tab, and wherein the interlocking tab protrudes outward from the swash plate when inserted into the anti-rotation hole.

Another aspect is directed to a method of locking relatively rotatable bodies in response to a force. The method includes engaging a first body with a swash plate comprising a swing arm, the swing arm having a first end and a second end, the second end comprising a plurality of teeth. The method further includes pivoting the first end of the swing arm on the swash plate so that the swing arm moves between a first position and a second position. The method further includes engaging a second body with a ratchet ring, the second body rotatable relative to the first body, the ratchet ring comprising a plurality of teeth. The method can also include locking the plurality of teeth of the swash plate to the plurality of teeth of the ratchet ring when the swing arm pivots towards the second position due to a high acceleration event.

A variation of the aspect further comprises biasing the spring arm towards the first position with a spring connecting the swash plate and the swing arm.

A variation of the aspect is, wherein pivoting the first end of the swing arm on the swash plate comprises pivoting the swing arm at a point proximate an edge of the swash plate.

A variation of the aspect further comprises securing the swing arm by and between the spring arm and a swing arm stopper.

A variation of the aspect further comprises inserting an interlocking tab to an anti-rotation hole on the swash plate.

### BRIEF DESCRIPTION OF THE DRAWINGS

The present disclosure is described with reference to the accompanying drawings, in which like reference characters reference like elements, and wherein:

FIG. 1 is an exploded view of an inertial latch according to a preferred embodiment of the present disclosure.

FIG. 2A is a top assembly view of the inertial latch from FIG. 1 in a resting condition with a bottom insert cover removed to show a swash plate in a first position.

FIG. 2B is a view similar to FIG. 2A except the swash plate has rotated to a second position or regular use condition without activating a swing arm.

FIG. 3A is a view similar to FIG. 2A except the swing arm has moved to partially engage with the ratchet ring due to a high acceleration condition.

FIG. 3B is a view similar to FIG. 3A except the swing arm has continued to move to fully engage with the ratchet ring due to the high acceleration condition.

FIG. 4 is an exploded view of an inertial latch according to another embodiment of the present disclosure.

FIG. 5 is a perspective view of the inertial latch from FIG. 4 in a resting condition with a bottom insert cover removed.

### DETAILED DESCRIPTION

Generally described, one or more aspects of the present disclosure relate to an inertial latch for a vehicle. In certain embodiments, this disclosure relates to an inertial latch that can lock two relatively rotatable bodies under high acceleration events. Such high acceleration events can include both rapid speeding or braking (e.g., greater than 1 g) and crash events (e.g., at least 3 g). In some embodiments, the inertial latch can include a swing arm that rotates with or relatively to a swash plate. The swing arm can rotate relative to the swash plate and lock into the ratchet ring to achieve a locking position (e.g., engaged position) when the inertial latch is experiencing a high acceleration event (e.g., speeding or braking). The swing arm can be rotated towards the locking position due to an inertia force. In some embodiments, the angle of rotation for the inertial latch to lock into the ratchet ring can be small (e.g., 0-20 degrees) such that any movement of the vehicle parts attached to the inertial latch during the high acceleration event is negligible.

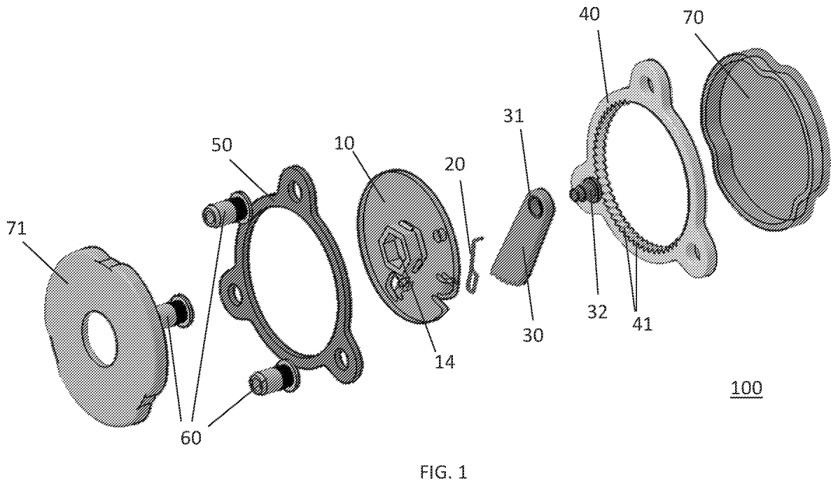

As shown in FIG. 1, an embodiment of an inertial latch 100 according to this disclosure can include a swash plate 10, a spring 20 (e.g., wire, plastic, etc.), and a swing arm 30. In some embodiments, the swash plate 10 can include a fastener 14 mounted to the swash plate 10 and configured to connect the swash plate 10 with a shaft such that the swash plate 10 may rotate with the shaft. In some embodiments, the swash plate 10 may be mounted to a hole in a center of the swash plate 10. In some embodiments, the hole may have a hexagonal shape. In some embodiments, the swing arm 30 can be attached to the swash plate 10 via a fastener (e.g., shoulder bolt) 32 and a washer 31. In some embodiments, the inertial latch 100 can include a spring holder 11 positioned on the swash plate 10 and configured to apply a first force on the swing arm 30. In some embodiments, the inertial latch 100 can include a swing arm stopper 12 positioned on the swash plate 10 and configured to apply a second force on the swing arm 30.

The inertial latch 100 can further include a ratchet ring 40. In some embodiments, the ratchet ring 40 can include a plurality of teeth 41 disposed along at least a portion of an inner rim of the ratchet ring 40. The inertial latch 100 can include an insert plate 50 that can be attached to the ratchet ring 40 using fasteners (e.g., nuts, rivnuts, etc.) 60. In some embodiments, the inertial latch 100 can include a top insert cover 70 attached to one side of the inertial latch 100 and a bottom insert cover 71 attached to the other side of the inertial latch 100.

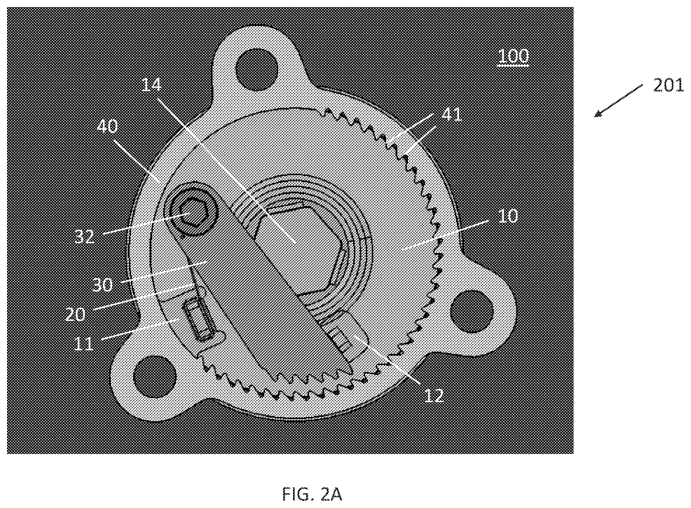

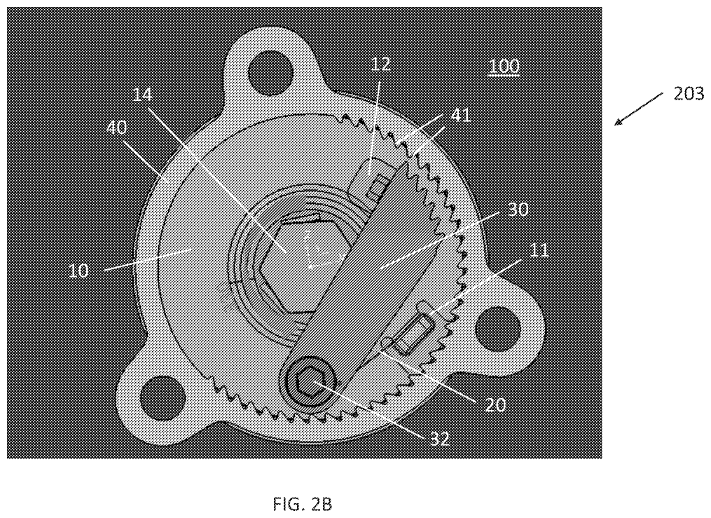

FIG. 2A is a top assembly view of the inertial latch 100 from FIG. 1 in a resting condition with the bottom insert cover 71 removed to show the swash plate 10 in a first position. FIG. 2B is a view similar to FIG. 2A except the swash plate 10 has rotated to a second position or regular use condition without activating the swing arm 30. In some embodiments, the swing arm 30 can be attached to the swash plate 10 via the fastener 32. In some embodiments, the spring holder 11 and the swing arm stopper 12 can be positioned on a side of the swash plate 10. In some embodiments, the spring 20 can connect the spring holder 11 and the swing arm 30.

In some embodiments, the inertial latch 100 can be implemented on a pivot point between two relatively rotatable parts of a vehicle. The two relatively rotatable parts may be connected through a shaft. In some embodiments, the swash plate 10 can be attached to the rotatable part of the two parts. For example, when the inertial latch 100 is implemented on an armrest, the armrest can be configured to rotate with the swash plate 10. Continuing with this example, the ratchet ring 40 can stay stationary relative to the vehicle.

During normal operation (e.g., in the absence of rapid speeding or braking), the inertial latch 100 can be in a resting condition 201 as illustrated in FIG. 2A or in a rotated position 202 as illustrated in FIG. 2B. When the inertial latch 100 experiences a level of acceleration that is less than a threshold acceleration, the inertial latch 100 operates in the normal operating conditions (e.g., FIGS. 2A and 2B) because an inertial force, if any, does not overcome a force applied by the spring 20 on the swing arm 30.

The inertial latch 100 can be implemented at any pivot point of two relatively rotatable parts. For example, when the inertial latch 100 is implemented on an armrest, the inertial latch 100 can be in the resting condition 201 when the armrest is folded up in a vertical position. The inertial latch 100 can be in the rotating condition (FIG. 2A) 202 when the armrest is being pulled down towards a horizontal position. When the inertial latch 100 moves from the resting condition 201 towards the rotating condition 202, all of the spring arm 30, spring holder 11, swing arm stopper 12 rotates with the swash plate 10, while the ratchet ring 40 stays stationary.

In some embodiments, as shown in FIG. 2A, a first end of the spring holder 11 can be attached to or part of an edge of the swash plate 10, and a second end of the spring holder 11 is connected to the swing arm 30 to apply the first force on the swing arm 30. In some embodiments, the swing arm stopper 12 can be configured to contact the swing arm 30 and apply the second force on the swing arm 30 that counters the first force. The swing arm 30 can be substantially secured in a normal operating condition by and between the spring holder 11 and the swing arm stopper 12 during a normal operating condition as shown in FIGS. 2A and 2B.

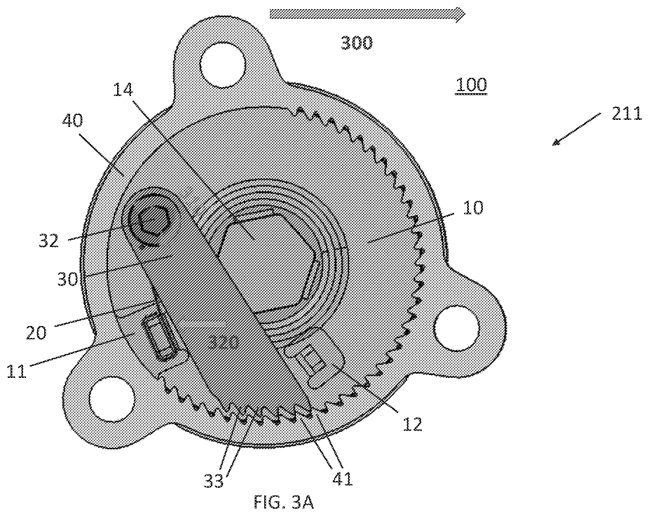

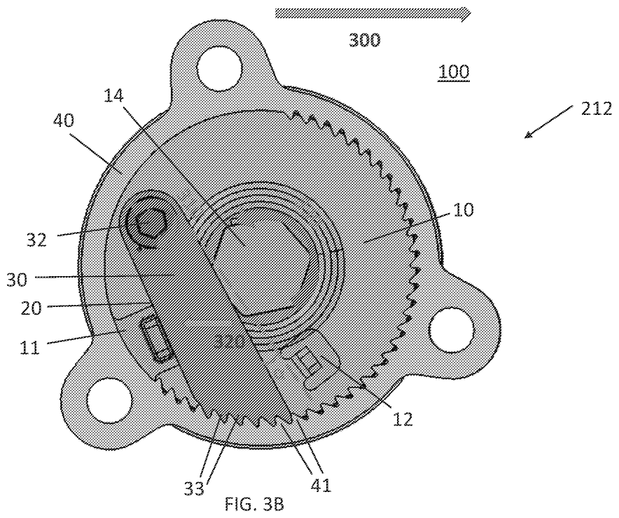

FIGS. 3A and 3B illustrate the inertial latch 100 during a high acceleration or deceleration event (e.g., a rapid speeding/braking or a crash of a vehicle). FIG. 3A is a view similar to FIG. 2A except the swing arm 30 has moved to partially engage with the ratchet plate 40 due to the high acceleration condition. FIG. 3B is a view similar to FIG. 3A except the swing arm 30 has continued to move to fully engage with the ratchet plate 40 due to the high acceleration condition. As is illustrated in FIGS. 3A and 3B, one end of the swing arm 30 can pivot around the fastener 32. A second end of the swing arm 30 can have a plurality of teeth 33. In some embodiments, the plurality of teeth 33 are configured to interact with the plurality of teeth 41 of the ratchet ring 40.

As shown in FIG. 3A, under an accelerating condition, the inertial latch 100 is moving with an acceleration in a direction 300. The swing arm 30 can move in a direction 320 against the spring 20 because of inertia, causing the swing arm 30 to rotate around the fastener 32 in a direction 310. In some embodiments, when the swing arm 30 is rotated in the direction 310 under the accelerating condition, the plurality of teeth 33 on an end of the swing arm 30 can move towards the plurality of teeth 41 of the ratchet ring 40. In some embodiments, in a partially engaged position 211, the force applied on the swing arm 30 by the spring 20 can be overcome by engagement force between the plurality of teeth 33 of the swing arm 30 and the plurality of teeth 41 of the ratchet ring 40 such that the swing arm 30 is locked in the partially engaged position 211. In other embodiments, the swing arm 30 may not be locked in the partially engaged position 211.

In some embodiments, the inertial latch 100 can be one-directional such that the inertial latch locks in a certain position under a high acceleration event in one of two opposing directions. For example, as illustrated in FIG. 3A, the swing arm 30 is configured to lock into the ratchet ring 40 when the swing arm 30 moves in the direction 320. The inertial latch 100 can reach a locking position 212 under high acceleration in the direction 300 but not under high acceleration in a direction opposite to the direction 300.

As shown in FIG. 3B, the inertial latch 100 can operate when experiencing an even greater acceleration to reach the locking position 212. In a high acceleration condition, the acceleration can be greater than a threshold acceleration G (e.g., 1 g-3 g). The plurality of teeth 33 on the swing arm 30 can move and lock into the plurality of teeth 41 of the ratchet ring 40 as shown in FIG. 3B. Under the high acceleration condition, wherein the acceleration is in the direction 300, the swing arm 30 rotates or pivots further around the fastener 32 and against the spring 20 in the direction 310 because of inertia. At the same time, under the high acceleration condition, the swash plate 10 can be configured to rotate in a direction 330, opposite to the direction 310, because of inertia. Rotation of the swash plate 10 in the direction 330 under acceleration and a centrifugal force resulting from its rotation can enhance the rotation of the swing arm 30 in the direction 310 and towards the plurality of teeth 41. After the swing arm 30 rotates for an angle of a from the swing arm stopper 12 as shown in FIG. 3B, the plurality of teeth 33 of the swing arm 30 interacts with the plurality of teeth 41 of the ratchet ring 40 such that the swash plate 10, along with the swing arm 30, can be locked in place by the stationary ratchet ring 40. The rotatable part attached to the swash plate 10 can thus be locked in place under the high acceleration condition.

Another aspect of this disclosure is that a latch assembly disclosed herein can also be used as a centrifugal latch where a centrifugal force instead of a linear inertial force is present. In some embodiments, the latch assembly can be actuated to lock two relatively rotatable parts when the rotating part rotates at a speed greater than 100 revolutions per minute (rpm). In other embodiments, the latch assembly can be actuated to lock two relatively rotatable parts when the rotating part rotates at another desirable threshold speed, depending on the geometries and masses of various parts of the latch assembly.

A person having ordinary skill in the art can appreciate that the angle of rotation of the swing arm 30 under a fixed force (e.g., the threshold acceleration required for the swing arm 30 to lock into the ratchet ring 40) can depend on a mass, a length, and a shape of the swing arm 30, a position of an attachment point of the swing arm 30 on the swash plate 10, a force applied by the spring holder 11, a position of the swing arm stopper 12, and an shape or angle of the teeth of the ratchet ring. For example, in some embodiments, the swing arm 30 of the inertial latch 100 can pivot at a point proximate to an edge of the swash plate 10. The swing arm 30 can extend from the point proximate to the edge of the swash plate 10 to another point proximate the edge of the swash plate 10. Positioning the pivot point of the swing arm 30 proximate the edge of the swash plate 10 can make the swing arm 30 swing with a greater angular acceleration (e.g., rotate for a greater angle) under a high acceleration event because of a longer inertial mass and a greater effect of centrifugal force. Therefore, one can vary one or more of the mass, the length, and the shape of the swing arm 30, the position of the attachment point of the swing arm 30 on the swash plate 10, the force applied by the spring holder 11, the position of the swing arm stopper 12, and the shape or angle of the plurality of teeth 41 on the ratchet ring 40 to achieve a similar result or a predictable different result (e.g., a different threshold acceleration value).

In some embodiments, after the inertial latch 100 reaches the locking position under a high acceleration condition, the inertial latch 100 can be reset to its normal operating conditions by causing the swash plate 10 to rotate opposite to the direction 330. For example, a rotatable part (e.g., an armrest) attached to the swash plate 10 can be rotated, thereby bringing the swash plate 10 to rotate opposite to the direction 330 as shown in FIG. 2B. When the swash plate 10 is rotated opposite to the direction 330, the swing arm 30 unlocks from the ratchet ring 40 (e.g., the plurality of teeth 33 of the swing arm 30 disengage from the plurality of teeth 41 of the ratchet ring 40). The inertial latch 100 can then be reset and operate in a resting condition 201 as illustrated in FIG. 2A or in a rotating condition 202 as illustrated in FIG. 2B.

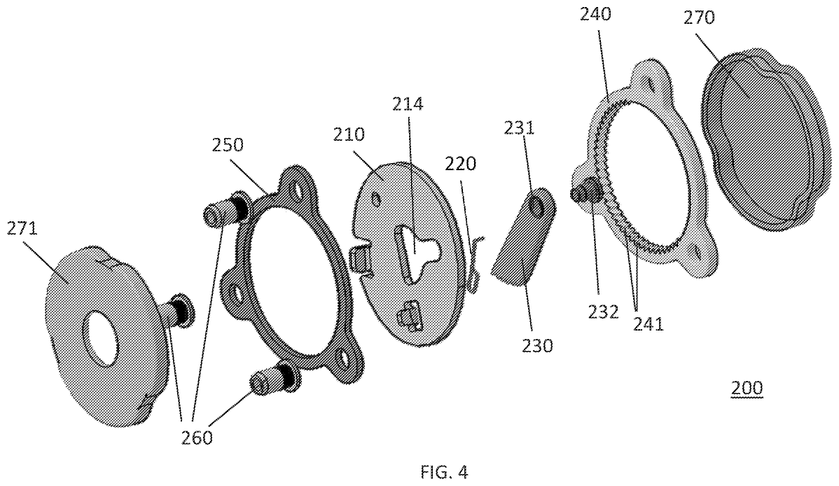

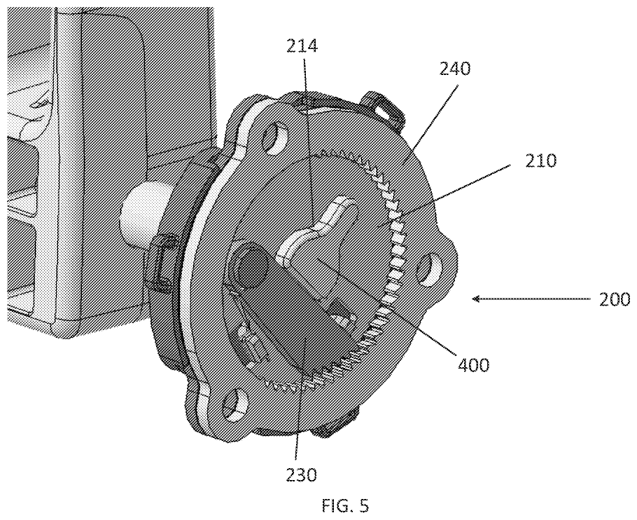

In various embodiments, as shown in FIG. 4, an inertial latch 200 disclosed herein can similarly include a spring 220, a swing arm 230, and a rachet ring 240. Unless noted otherwise, similarly numbered components of the inertial latch 200 may function similarly as those of the inertial latch 100. In some embodiments, the inertial latch 200 can include a swash plate 210 having an anti-rotation hole 214 as opposed to a fastener 14 (see FIG. 1-3B). In some embodiments, the anti-rotation hole 214 is disposed in a center of the swash plate 210. In some embodiments, it may be desirable to include the anti-rotation hole 214 in the center of the swash plate 210 to reduce torque and increase efficiency of the inertial latch 200. In some embodiments, the anti-rotation hole 214 can extend from the center of the swash plate 210 towards a periphery/edge of the swash plate 210, approximately in a T-shape as shown in FIG. 4. When the anti-rotation hole 214 is available on the swash plate 210, the inertial latch 200 can be used with an interlocking tab 400 (see FIG. 5) configured to be inserted inside the anti-rotation hole 214. Advantageously, the interlocking tab 400 may be configured to extend outward from the swash plate 210 to stop the swing arm 230 and further prevent rotation of the swash plate 210 under the high acceleration condition.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed inertial latch. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. An inertial latch comprising:
a swash plate;
a swing arm having a first end and a second end, the first end being configured to pivot on the swash plate so that the swing arm moves between a first position and a second position, the second end comprising a plurality of teeth;
a spring connecting the swash plate and the swing arm, the spring being configured to apply a force on the swing arm to bias the swing arm in a direction towards the first position; and
a ratchet ring comprising a plurality of teeth configured to be engaged by the plurality of teeth of the swing arm when the swing arm pivots to the second position due to a high acceleration event.

2. The inertial latch of claim 1, wherein the first end of the swing arm is pivot at a point proximate an edge of the swash plate.

3. The inertial latch of claim 1, wherein the second end of the swing arm is proximate an edge of the swash plate in the first position.

4. The inertial latch of claim 1, wherein the spring connects to the swash plate proximate an edge of the swash plate.

5. The inertial latch of claim 1, wherein the high acceleration event is when the inertial latch is under an acceleration or deceleration at or exceeding 1 g.

6. The inertial latch of claim 1, wherein the high acceleration event is when the inertial latch is under an acceleration or deceleration at or exceeding 3 g.

7. The inertial latch of claim 1, wherein, in the first position, the swing arm is substantially secured by and between the spring arm and a swing arm stopper.

8. The inertial latch of claim 7, wherein the swing arm stopper is positioned on the swash plate.

9. The inertial latch of claim 1, wherein, in the second position, the plurality of teeth on the second end of the swing arm locks into the plurality of teeth on the ratchet ring.

10. The inertial latch of claim 1, wherein the swash plate is connected to a pivoted part.

11. The inertial latch of claim 10, wherein the pivoted part can rotate with the swash plate when the swing arm is in the first position.

12. The inertial latch of claim 10, wherein the pivoted part is locked in place when then swing arm is in the second position.

13. The inertial latch of claim 1, wherein the swash plate comprises an anti-rotation hole.

14. The inertial latch of claim 13, wherein the anti-rotation hole extends from a center of the swash plate towards a periphery of the swash plate.

15. The inertial latch of claim 13, wherein the anti-rotation hole is sized and shaped to receive an interlocking tab, and wherein the interlocking tab protrudes outward from the swash plate when inserted into the anti-rotation hole.

16. A method of locking relatively rotatable bodies in response to a force, the method comprising:
engaging a first body with a swash plate comprising a swing arm, the swing arm having a first end and a second end, the second end comprising a plurality of teeth;
pivoting the first end of the swing arm on the swash plate so that the swing arm moves between a first position and a second position;
engaging a second body with a ratchet ring, the second body rotatable relative to the first body, the ratchet ring comprising a plurality of teeth; and
locking the plurality of teeth of the swash plate to the plurality of teeth of the ratchet ring when the swing arm pivots towards the second position due to a high acceleration event.

17. The method of claim 16, further comprising biasing the spring arm towards the first position with a spring connecting the swash plate and the swing arm.

18. The method of claim 16, wherein pivoting the first end of the swing arm on the swash plate comprises pivoting the swing arm at a point proximate an edge of the swash plate.

19. The method of claim 16, further comprising securing the swing arm by and between the spring arm and a swing arm stopper.

20. The method of claim 16, further comprising inserting an interlocking tab to an anti-rotation hole on the swash plate.
